(19) United States
(12) Patent Application Publication
(10) Pub. No.: US 2006/0186344 A1
(43) Pub. Date: Aug. 24, 2006

(54) SENSOR HAVING A UV-PERVIOUS QUARTZ GLASS

(76) Inventors: Fang-Sheng Hsu, Hsin-Chu Hsien (TW); Sen-Huang Huang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/907,676

(22) Filed: Apr. 12, 2005

(30) Foreign Application Priority Data
Feb. 21, 2005 (TW) 094105078

(51) Int. Cl. G01J 1/42

(52) U.S. Cl. 250/372

(57) ABSTRACT

A sensor includes a photosensitive resistor and a quartz glass located on the photosensitive resistor. The resistance of the photosensitive resistor variably changes with the received light rays. The quartz glass is used for filtering light incident onto the photosensitive resistor, and mainly allows UV light rays to travel therethrough.

### BACKGROUND OF INVENTION

1. Field of the Invention

The present invention relates to a sensor, and more particularly, to a sensor having a UV-pervious quartz glass.

2. Description of the Prior Art

The Earth's ozone layer has been under attack by chlorofluorocarbons (CFCs) output from factories for a long time. This has led to the increase in ultraviolet (UV) radiation reaching the ground. UV light rays can cause dermopathy. If the strength of incident UV light rays can be detected immediately, human beings can directly protect themselves from harm. When UV radiation is considerable, people can stay inside and avoid going outside to protect themselves from the effects of UV radiation.

Generally, UV light rays are of three types: UV-A having wavelengths from 320 nm to 400 nm, UV-B having wavelengths from 280 nm to 320 nm, and UV-C having wavelengths shorter than 280 nm. UV-C is the most dangerous of the three types. Fortunately, there is little UV-C radiation at ground level. However, due to the reduction of the ozone layer, UV-B radiation around the ground is dramatically increasing, rather than the less dangerous UV-A radiation. That is because the absorption efficiency of UV-B of the aerosphere is about 100 to 1000 times the absorption efficiency of UV-A. Therefore, the reduction of the ozone layer has resulted in great increase of UV-B at ground level.

Please refer to FIG. 1, which is a graph of an erythema action spectrum. For human beings, the main wavelength range causing skin to turn red is between 280 nm and 298 nm UV-B, whose weighted coefficient is 1. When the wavelength is longer than 298 nm, the weighted coefficient drops quickly. The weighted coefficient drops to around one over ten thousand when the wavelength is about 400 nm.

Therefore, we should detect the UV-B wavelength range from 280 nm to 298 nm to protect human health from UV radiation. However, conventional UV detectors, such as a photo multiplier tube, a silicon UV detector, and an AlGaN UV detector, are not suitable to be implemented for UV-B detection. The photo multiplier tube requires high voltage; its volume is large and it is not easy to operate. Also, the cost in making the photo multiplier tube is high. The silicon UV detector mainly detects visible light (wavelengths from 400 nm to 760 nm), and has an overall range of 350 nm to 950 nm. Therefore, the sensitivity of the silicon UV detector is not good enough to detect UV light rays. Although the AlGaN UV detector mainly detects wavelengths from 200 nm to 365 nm, it is susceptible to a lattice defect in manufacture. It is difficult to control this issue and the production yield is low.

### SUMMARY OF INVENTION

It is therefore a primary objective of the claimed invention to provide a sensor, which includes a UV-pervious quartz glass, to solve the above-mentioned problem.

The claimed invention provides a sensor including a photosensitive resistor whose output value changes with received light rays, and a quartz glass located on the photosensitive resistor for filtering light incident onto the photosensitive resistor. The quartz glass mainly allows UV light rays to travel therethrough.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a graph of an erythema action spectrum.

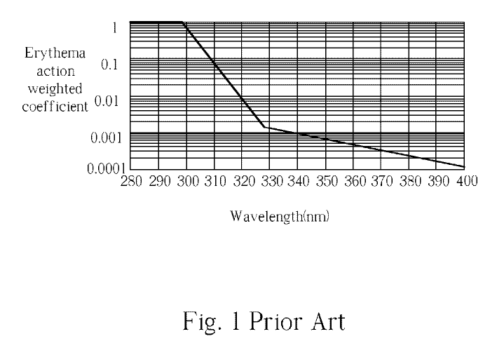

FIG. 2 is a diagram of a sensor according to the present invention.

### DETAILED DESCRIPTION

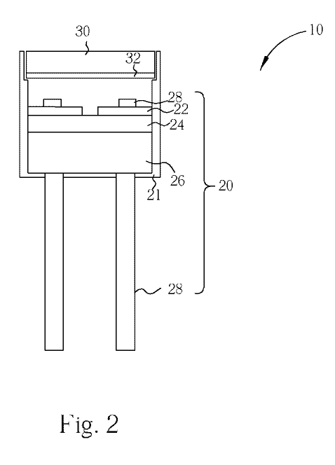

Please refer to FIG. 2, which is a diagram of a sensor 10 according to the present invention. The sensor 10 comprises a photosensitive resistor 20 and a UV-pervious quartz glass 30. The photosensitive resistor 20 comprises two electrodes 22, a zinc sulfide (ZnS) layer 24, a ceramic substrate 26, two lead terminals 28, and a holder 21. The ceramic substrate 26 is placed on the inner side of the holder 21. The ZnS layer 24 is placed on the ceramic substrate 26 for receiving light rays. The two electrodes 22 are placed on the ZnS layer 24. The two lead terminals 28 respectively pass through the electrodes 22, the ZnS layer 24, and the ceramic substrate 26 to act as two terminals of the photosensitive resistor 20. The holder 21 is made of ceramic material or other materials.

The ZnS layer 24 is photoconductive material. When light reaches the ZnS layer 24, carriers are generated in the ZnS layer 24 to promote the electric conductivity of the ZnS layer 24. Thus, the resistance between the two electrodes 22 changes with the light rays received by the ZnS layer 24. Please note that in the prior art, the commonly used photoconductive material is cadmium sulfide (CdS), which mainly detects visible light having wavelengths over 540 nm, and thereby CdS is not suitable to detect UV light rays. The reason why the present invention utilizes the ZnS layer 24 is that the ZnS layer 24 mainly detects UV light rays having wavelengths shorter than 380 nm, which is more suitable to be implemented in the present invention.

The quartz glass 30 is placed on the photosensitive resistor 20, and mainly allows UV light rays to travel therethrough. One side of the quartz glass 30 includes a silver layer 32 whose purity is over 99%. Adjusting the thickness of the silver layer 32 can filter UV light rays of undesirable specific frequencies, such that the photosensitive resistor 20 only receives un-filtered UV light rays. For example, the thickness of the silver layer 32 can be adjusted to allow UV light rays having wavelengths from 280 nm to 380 nm to reach the ZnS layer 24 of the photosensitive resistor 20 for changing the resistance of the photosensitive resistor 20. As long as the thickness of the silver layer 32 is proper, the wavelength range of UV light rays passing through the silver layer 32 can be controlled. In the present invention, the ZnS layer 24 can be replaced with other photoconductive materials capable of detecting UV light rays.

As mentioned above, UV-B radiation does great harm to human beings. Therefore, the quartz glass 30 is made to allow UV-B to pass through, and to cooperate with the photosensitive resistor to efficiently detect UV-B rays. The present invention can be applied in products related to UV detection. When the strength of UV-B radiation on an ultraviolet index (UVI) exceeds the allowable range, the resistance of the sensor 10 of the present invention changes. The output value of the sensor 10, the resistance, can be converted into current or voltage by using a simple circuit.

Compared to the prior art, the present invention provides a sensor to detect a specific wavelength range. Compared to the photo multiplier tube, the silicon UV detector, and the AlGaN UV detector, the present invention is more suitable to be implemented in UV-B detection products, and is easily mass produced. However, the present invention is not intended to be limited to specific UV-B wavelength ranges. The thickness of the silver layer on the quartz glass can be adjusted depending on different requirement to filter different wavelength ranges of UV light rays.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensor comprising:
a photosensitive resistor whose output value changes with received light rays; and
a quartz glass located on the photosensitive resistor for filtering light rays incident onto the photosensitive resistor.

2. The sensor of claim 1 wherein the quartz glass mainly allows ultraviolet (UV) light rays to travel therethrough.

3. The sensor of claim 2 further comprising a silver layer formed on a side of the quartz glass for filtering UV light rays of undesirable specific frequencies.

4. The sensor of claim 3 wherein the purity of the silver layer is over 99%.

5. The sensor of claim 3 wherein the wavelengths of UV light rays arranged to travel through the silver layer are between 280 nm and 380 nm.

6. The sensor of claim 1 wherein the photosensitive resistor comprises:
a holder;
a ceramic substrate placed on the inner side of the holder;
a zinc sulfide (ZnS) layer placed on the ceramic substrate for receiving light rays;
two electrodes placed on the ZnS layer; and
two lead terminals respectively passing through the two electrodes, the ZnS layer, and the ceramic substrate, as two terminals of the photosensitive resistor.

7. The sensor of claim 6 wherein the holder is made of ceramic material.

8. A sensor comprising:
a holder;
a ceramic substrate placed on the inner side of the holder;
a ZnS layer placed on the ceramic substrate for receiving light rays;
two electrodes placed on the ZnS layer; and
two lead terminals respectively passing through the two electrodes, the ZnS layer, and the ceramic substrate.

9. The sensor of claim 8 further comprising a quartz glass placed on the holder.

10. The sensor of claim 9 wherein the quartz glass mainly allows UV light rays to travel therethrough.

11. The sensor of claim 9 further comprising a silver layer formed on a side of the quartz glass for filtering UV light rays of undesirable specific frequencies.

12. The sensor of claim 11 wherein the purity of the silver layer is over 99%.

13. The sensor of claim 11 wherein the wavelengths of UV light rays arranged to travel through the silver layer are between 280 nm and 380 nm.

14. The sensor of claim 8 wherein the holder is made of ceramic material.
